(19) United States
(12) Patent Application Publication
(10) Pub. No.: US 2014/0149314 A1
(43) Pub. Date: May 29, 2014

(54) System and Method for Monitoring Compliance Regarding Investment Thresholds and Accredited/Non-Accredited Status of Investors

(71) Applicants: Keith Allen Blakely, Buffalo, NY (US); Robert Christopher Carbone, Buffalo, NY (US)

(72) Inventors: Keith Allen Blakely, Buffalo, NY (US); Robert Christopher Carbone, Buffalo, NY (US)

(21) Appl. No.: 14/092,278

(22) Filed: Nov. 27, 2013

Related U.S. Application Data
(60) Provisional application No. 61/730,547, filed on Nov. 28, 2012.

(51) Int. Cl. G06Q 40/06; G06Q 30/00; G06Q 20/40

(52) U.S. Cl. CPC G06Q 40/06; G06Q 30/018; G06Q 20/405
USPC 705/36 R; 705/317; 705/44

(57) ABSTRACT

A central database for platform compliance regarding investment thresholds and accredited investor verification that is coupled with, or able to be integrated with, a managed payments and escrow service or a third-party payment and escrow service. At the center of the platform is an application programming interface (API) that exchanges information between the system and a host of parties including, without limitation, intermediaries, third-party data sources, payments and escrow vendors.

### CROSS-REFERENCE TO RELATED APPLICATION

The present application claims priority benefit of U.S. Provisional Patent Application No. 61/730,547 entitled “System and Method for Monitoring Compliance Regarding Investment Thresholds and Accredited/Non-Accredited Status of Investors,” filed on Nov. 28, 2012, which is incorporated herein by reference.

### BACKGROUND OF THE INVENTION

The JOBS Act was signed into law in 2012 which permits two new methods of raising capital: Rule 506(c) of Regulation D whereby individuals and enterprises can raise capital by selling unregistered securities marketed through general solicitation and advertising, provided that all purchasers are accredited, and a new “crowdfunding” exemption whereby individuals and enterprises can raise capital by selling unregistered securities marketed through general solicitation and advertising to both accredited and non-accredited purchasers.

The use of general solicitation and advertising to market offerings of securities has been widely referred to as “crowdfunding,” also known as “crowdsourcing.” In the United States, crowdfunding had been effectively banned prior to the enactment of the JOBS Act due to the restrictions imposed by the Securities Exchange Act of 1933 that required all offerings of securities to be registered with the SEC if the offeror used “general solicitation or advertising” to promote offerings. The registration process is costly and generally renders such transactions cost prohibitive. Under an SEC rule known as Regulation D (a.k.a. Rule 506), there are narrow exceptions to the registration requirement available for offerings made to “accredited investors”—i.e., wealthy individuals that meet certain income or net worth thresholds. Furthermore, the prohibition on general solicitation, even in private placements to accredited investors, has rendered an appeal to the general public for capital illegal.

In 2012, the Jumpstart Our Business Startups Act (“JOBS Act”) was signed into law which mandated radical changes to the regulatory environment for private placements so as to allow crowdfunding under a new exception, as well as authorizing the use of general solicitation in offerings that continue to rely on Rule 506 of the Regulation D exemption under new subsection 506(c). With respect to Rule 506(c), the major regulatory distinctions with a conventional Rule 506(h) offering include the fact that only accredited investors can purchase securities offered in reliance upon Rule 506(c) and issuers must take reasonable measures to verify the accredited status of investors. The SEC provided a non-exclusive list of means of accredited verification that meet the standard of reasonableness, including review of financial documentation from the investor and certification by a registered investment adviser, registered broker dealer, certified public accountant, or licensed attorney.

The process of collecting financial information and financial documentation directly from investors is intrusive, burdensome and not scalable. It generally would require issuers, or intermediaries assisting an issuer, to implement manual processes for collection and review of this documentation and these certifications. Investors do not want individuals being exposed to their sensitive financial information and do not want to have to go through redundant compliance processes requiring such disclosures as they make repeat investment in other issuers through other funding portals. Additionally, the chain of custody of documentation flowing through the investor seeking the accredited certification creates opportunities for forgery or falsification of this documentation. Subsequently, there is a need for a service that can aggregate accredited verifications and the evidence upon which accredited verifications are based and act as a an independent, third-party custodian for said evidence and supply such evidence, or provide a certification of accredited status, to multiple issuers or intermediaries through which an investor seeks to purchase securities. Where possible, this service should pull information from third-party databases such as the Internal Revenue Service and records of accounts with financial institutions to serve as the basis for an accredited certification, or to verify information provided by the investor, to minimize the likelihood of falsification or forgery by the investor. This service can also integrate with a payment and escrow service to manage the funding of the offering that ensures only accredited investors can transfer funds into escrow.

A major compliance requirement imposed by the JOBS Act upon the new crowdfunding exemption is that non-accredited investors are limited in the annual amount of capital that they may invest. The JOBS Act amended the Securities Act of 1933 to read that platforms must: “make such efforts as the Commission determines appropriate, by rule, to ensure that no investor in a 12-month period has purchased securities offered pursuant to [the crowdfunding exception] that, in the aggregate, from all issuers, exceed the limits set . . . .” Currently, investors with annual income or net worth of less than $100,000 may invest no more than the greater of $2,000 or 5% of their annual income or net worth in any twelve month period in an offering company. Individuals with annual income or net worth of more than $100,000 may invest up to 10% of their annual income or net worth annually (with a cap of $100,000 per investor, per company annually).

There is virtually no way that crowdfunding platforms can effectively police the amount of investment made by investors in crowdfunding offerings without knowing what has been invested on other platforms. A basic self-reporting mechanism would be rife with problems. For example, an investor may register for multiple offerings on multiple platforms and self-report that he is under the investment threshold, not knowing whether he will be included in some or all of the deals. The information may be correct at the time but upon closing of multiple transactions the investor may exceed the threshold. Additionally, with the potential for an investor to have small investments in hundreds (if not more) enterprises on dozens of platforms, the requirement to disclose all of one's crowdfunding investments on every platform over which an investment is sought would be administratively burdensome and prone to inaccuracy. In fact, investor information will be viewed as a risk by the platforms because the JOBS Act mandates that crowdfunding platforms protect investor information. Accordingly, platforms will not be inclined to unnecessarily expose themselves to investor information related to external transactions which they will then have a duty to protect. Also, the function of checking and policing the accuracy of self-reported information is not a core competency of the platforms.

Accordingly, there is a need for a method and a system that could be used by a third party to aggregate the transactional data from all of the platforms (or as many as will participate) and to provide a screening feature by means of a report or certification that can be used to bounce investors out of transactions. This service can also integrate with a payment and escrow service to manage the funding of the offering that ensures only investors who are under their applicable threshold can fund the offering at closing.

### SUMMARY OF THE INVENTION

The system and method of the present invention meets the above described needs by providing a central database for platform compliance regarding investment thresholds and accredited investor verification that is coupled with, or able to be integrated with, a managed payments and escrow service or a third-party payment and escrow service. At the center of the platform is an application programming interface (API) that exchanges information between the system and a host of parties including, without limitation, intermediaries, third-party data sources, payments and escrow vendors. Issuers will log onto an intermediary's user interface and setup an offering which may include selection of whether the offering is relying upon Rule 506(c) or the crowdfunding exemption. Investors log onto an intermediary's user interface and enter personally identifying information and financial information that is relevant to crowdfunding transactions. Depending upon the type of exemption being relied upon, the intermediary will transmit the aforesaid offering and investor information to the system via API.

For offerings based upon Rule 506(c), intermediaries may electronically transmit information and/or documents to the system via API that enable records to be automatically created or modified for individual investors in the system database. Additionally, investors may initiate a process through the intermediary user interface (or intermediaries may initiate the process for their own account) whereby the system electronically requests information from third-party databases including, without limitation, the Internal Revenue Service and records of financial institutions to provide evidence that an investor meets or exceeds the definition of an accredited investor as defined by the Securities and Exchange Commission or other regulatory body. Once the system has received the information from these third-party data sources, the system API automatically makes a determination of whether the evidence is sufficient to meet the rule for accreditation and transmits a response to the intermediary or, in the alternative, provides the information received from the third-party data sources to the intermediary in the format received or in a format developed by the system. This verification of accredited status and/or the data received from the third-party data sources is then stored in an encrypted data vault. The system will retransmit the accredited verification or the data to future intermediaries through which an investor seeks to transact business, provided the data is still accurate and valid and continues to evidence an investor's entitlement to accredited status. This entire process is electronic and automated from end-to-end, including the process of obtaining consents from investors which may be done through an electronic signature process hosted by the intermediary or the system.

For offerings based upon the crowdfunding exemption, intermediaries call upon the system API to create or update investor and issuer records in the system's database which are shared among all intermediaries. These updates are done upon the occurrence of certain events including, without limitation, the creation of an offering by an issuer, the modification of an offering by an issuer, the closing of an offering by an issuer, the subscription to an offering by an investor, the modification of a subscription by an investor, the funding of an offering by an investor, and the closing of an offering by an investor. Upon attempted subscription to an offering, the intermediary calls upon the system API with information about the subscription and requests either the investment history of the investor or whether the investor may subscribe to the offering based on the Investment Threshold rules, which will be provided in the response to the API request. If the intermediary requests the latter, the system API determines whether, based on the investment history associated with the investor account and the Investment Threshold rules, the investor may proceed with the subscription and provides this determination in the response to the API request.

Where the Investment Threshold rules require income or net worth to be entered to calculate the upper limit of the threshold—e.g., where an investor would exceed a permissible baseline threshold—the system API will alert the intermediary in the response to the API request which will prompt the intermediary to collect this information from the investor or to initiate an income verification or asset verification process through the system. If the income verification or asset verification processes are managed by the system, the investor record in the system database will be updated and will serve as the benchmark for the investor's investment threshold for as long as the information is valid pursuant to the Investment Threshold rules. Once the information is no longer valid, the system will automatically reinitiate the income and asset verification processes in future transactions, where applicable (e.g., where the investor again exceeds a certain permissible baseline threshold).

Both the accredited verification databases and crowdfunding verification databases can be coupled with an electronic payments and escrow function that is managed by the system or a third-party vendor. The accredited verification services or crowdfunding verification services serve as a necessary blocker to funding an escrow account, or release of funds from the escrow account to the issuer, managed by the system or a third-party vendor. Once the system API recognizes an investor as being compliant for the transaction, the intermediary can pass electronic payment information to the system that will enable the system, or a vendor of the system, to automatically direct transfer of funds by the investor to an escrow account. In the alternative, investors can open accounts managed by the system, or a third-party vendor of the system, through a user interface managed by the system and the system can load funds into the accounts at the direction of the investor and automatically orchestrate release of funds from the accounts into offerings through the system-supported intermediaries via API provided that the investor meets the applicable compliance screening processes.

### BRIEF DESCRIPTION OF THE DRAWINGS

The invention is illustrated in the drawings in which like reference characters designate the same or similar parts throughout the figures of which:

FIG. 1 schematically illustrates the major components of the system;

FIG. 2 is a schematic representation of the functional architecture of the system;

FIG. 3 is a schematic representation of the physical components of the system; and,

FIG. 4 is a flow chart for a method according to the system.

### DETAILED DESCRIPTION OF THE INVENTION

The system and method of the present invention provides a platform at the center of the investor accreditation and the investment transaction itself The system is a software as a service (Saas) solution with an API-driven architecture. The system tracks investments by investors both individually and as directed from multiple crowdfunding platforms and blocks investors from participating in transactions when they exceed SEC investment thresholds or when they attempt to participate in an unauthorized transaction (i.e., non-accredited investors in Regulation D transactions). Investors can store and view their transaction history, their portfolio of investments, and their available capital for future transactions.

The system provides for transparent integration with offerors and may be configured as a backoffice solution for regulatory compliance and investment transactions. The system offers both a web-based workflow and deep, API-driven integration.

The system implements a full Internet presence that allows consumers to create accounts on a web site as initiated from either the system web site itself or from an offeror's web application. For example, the system web site provides the user with the ability to create a system account to be referenced when interacting with a crowdfunding company. However, the primary workflow may be where the user is directed to the system website from a crowdfunding client company.

The system includes an investor dashboard with four basic tabbed sections. The first section may be a personal information section with forms to ascertain social security number, net worth, annual income, employer name and contact information. This section includes a secure drop box where investors can upload pay stubs, tax returns, and other documents to verify income/net worth. The second section may include pending transactions. This section populates with all pre-closing transactions that the investor has registered to invest in. The third section may include the transaction history. The transaction history includes a list of past transactions by platform, offeror, etc. A graphical display of the portfolio such as a pie chart of holdings by company, sector, type of security etc. and a line graph of investment activity over time may also be included. This section may also include storage space for past transaction deal documents and stock certificates. Also, a threshold monitor may be included which captures financial information from the investor and captures financial information about transactions via API's with the crowdfunding platforms. This information is used to compute how much more an investor may presently invest, invest in three months, invest in six months, etc. based on the business rules (i.e., the trailing twelve month investment limit and accredited/non-accredited status). The fourth section may include the funding sources and provides a function for adding or removing specific funding sources such as electronic payment services. This section may also include a record of past payment transfers.

Governmental entities (e.g., the SEC) may also require access to information disclosed to the system. This access may be handled by a dedicated API endpoint in the system that reveals only the required data.

When an offeror chooses to, they may send their customers through a system-managed account creation and verification flow. This flow is similar to an electronic payment service checkout “tunnel,” wherein an account is created if it does not exist, investment history is accessed, and the consumer is sent back to the referring source with success or failure messages to be used by the platform in communicating with investors. The referring offeror handles the remainder of the communications with the customer.

### System API

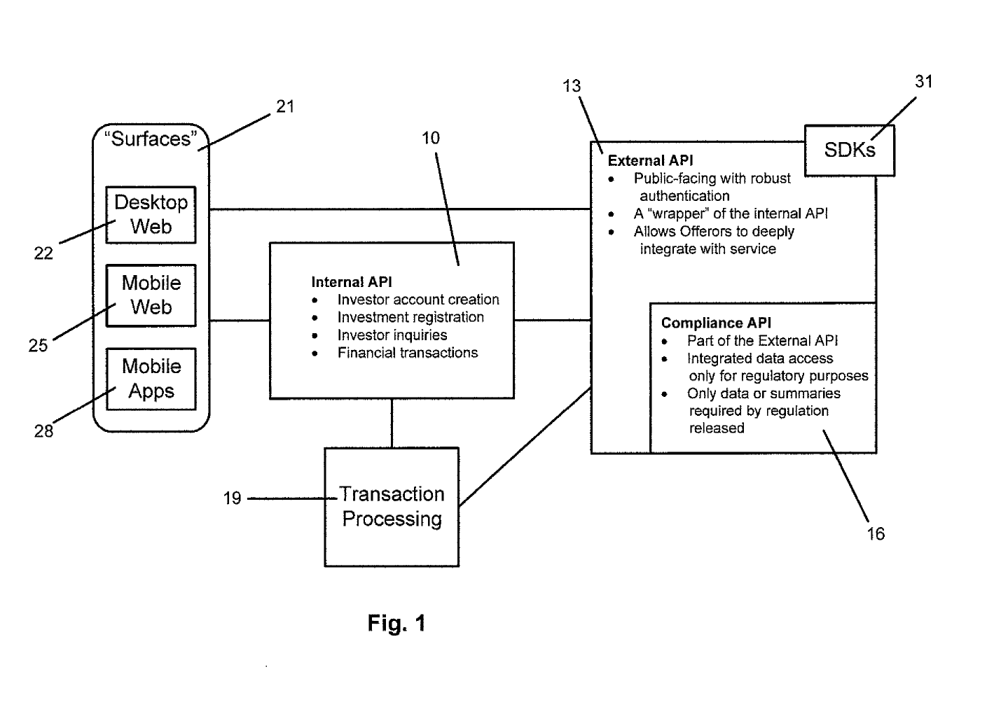

The API is a RESTful interface for both internal and external use. Representational State Transfer (REST) is a style of software architecture for distributed systems. REST has emerged as a predominant Web service design model. Turning to FIG. 1, the internal API 10 may only be called on by internal systems. Each set of features from web transactions to lookups to compliance reporting is authenticated and locked down to system-provided access, including backoffice-only features and Web-facing features that the system website interface may utilize. The external API 13 is a public facing “wrapper” of a subset of internal API features. It has features including, but not limited to, authentication, investor profile lookup, investment lookup, investor registration, and investment registration. The system also may define a compliance data interchange 16 with federal entities such as the SEC. The exchange may minimally provide flat file exports on a regular basis or it may provide a rich API endpoint or dashboard for regulatory inquiry.

In FIG. 1, a schematic representation illustrates the internal API 10 of the system, the external API 13 of the system, and the compliance API 16 within the external API 13. The internal API 10 and the external API 13 both communicate with the transaction processing function 19 which may be performed by a third-party electronic payment service or financial institution. The internal and external API 10, 13 are also connected to the users via “surfaces” 21 such as desktop computer Internet access 22, mobile Internet connection 25, or mobile apps 28. The depicted software development kits (SDK's) 31 provide language- or framework-specific implementations of the API, making integration easier for platforms.

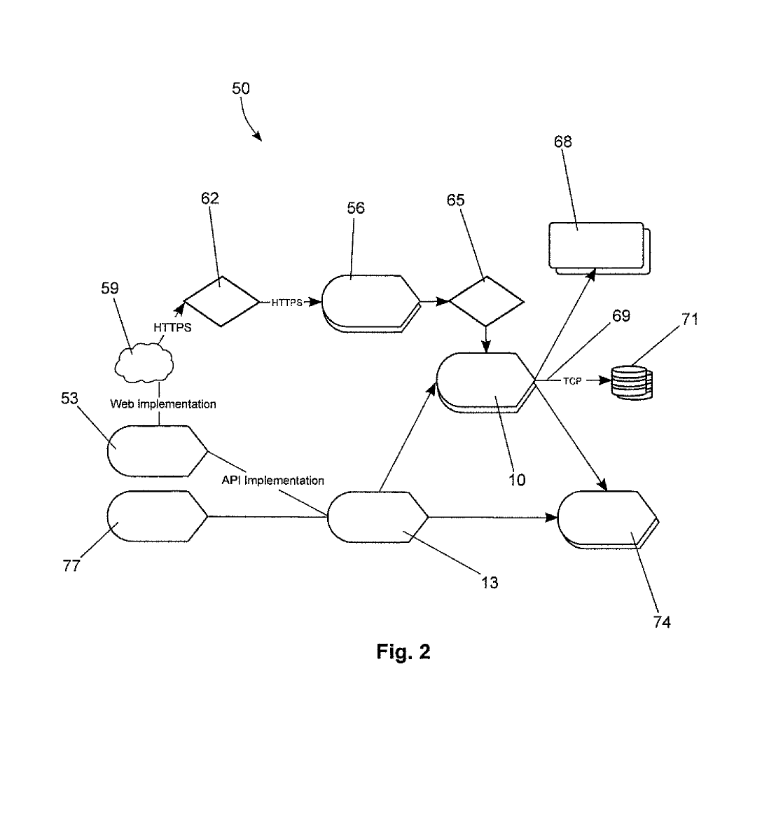

In FIG. 2, a schematic illustration of the functional architecture of the system is shown. With information requests and updates flowing from left to right, both the Web form- and API-based implementations are depicted. Where appropriate, possible connection protocols are noted. The system 50 implements a full Internet presence that allows investors to create accounts on a website as initiated from either the system website itself or from an issuer/offeror's web application. As shown in the figure, the partner interface 53 may provide a starting point for either directing the investor to a web user interface 56 or for accessing the system 50 through the offeror's web application by means of interfacing via the external API 13 of the system 50. The investor at the partner interface/web site 53 may be directed from that website to the user interface 56 for the system 50 web site by means of the Internet 59 and one or more load balancers 62. The system web user interface 56 is configured to interface directly with the internal API 10 by means of load balancer 65. The internal API 10 is connected to file storage 68 and is connected by a TCP line 69 to a relational database management system (RDBMS) 71. The internal API 10 may be connected to payment and other financial interfaces 74.

Returning to the left hand side of the figure, the system 50 may also operate directly through the partner interface/web site 53 via the external API 13. The external API 13 may also interface with mobile application 77 in a similar manner. The external API 13 communicates with the internal API 10. Requests for verification and for financial information can be delivered to the internal API 10 in this manner and the internal API 10 which is secure will respond to the requests with appropriate security safeguards for determining the information delivered to the partner interface via the external API 13. The external API 13 may also communicate with payment and other financial interfaces 74.

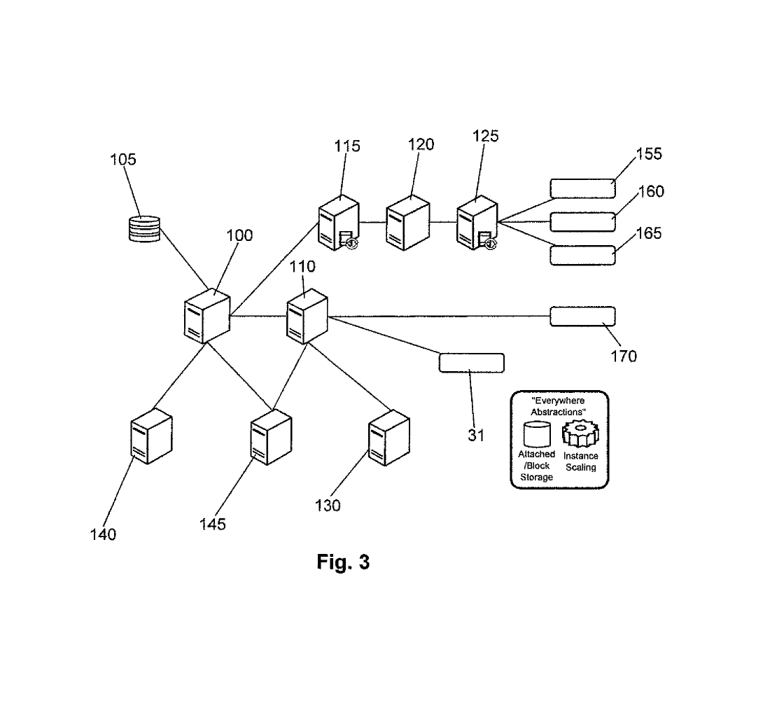

FIG. 3 is a schematic illustration of the physical components of the system of the present invention. The system may be deployed in either physically-hosted or cloud computing environments, allowing for adaptation of the system to meet scaling and compliance needs. Components such as databases, Web servers, proxy/cache servers, third-party partners and vendors, and client endpoints are depicted. The physical components shown in the figure are one embodiment of the invention. As will be known to persons of ordinary skill in the art based on this disclosure, the servers and their functionality can be realized in a centralized fashion or in one computer system or in a distributed fashion wherein different elements are spread across several interconnected computer systems.

A network server 100 provides the internal API. The server 100 interacts with database 105, server 110 (external API), server 115, server 120, server 125, intermediary network computer 130 (via API), escrow account server 140, and payment transaction server 145 over a network. Servers 115, 120 and 125 provide for the direct Internet pathway for the system website via desktop computers 155, partner websites 160 (which have links that the investor follows to reach the system website user interface), or mobile web applications 165 which all send the investors directly to the system website.

Alternatively, the system may also be accessed via API through mobile apps 170 or within the intermediary network computer 130 as a “backoffice solution.” In this manner, the system external API functions are performed within the partner web application in a seamless manner.

The above system may be implemented in the following manner, Issuers may log onto an intermediary's user interface and set up an offering which may include selection of whether the offering is relying upon Rule 506(c) or the crowdfunding exemption. Investors may log onto an intermediary's user interface and enter personally identifying information and financial information that is relevant to Rule 506(c) or crowdfunding transactions. The intermediary network computers may electronically transmit information and/or documents to the system via external API which enables records to be automatically created or modified for individual investors in the database. Depending on the type of exemption being relied upon, the intermediary will transmit the offering and investor information to the system via the external API. This information could also be provided directly by the investors at the user interface for the system website. Additionally investors may initiate a process through the intermediary user interface (or intermediaries may initiate the process for their own account) whereby the system electronically requests information from third-party databases including, without limitation, the Internal Revenue Service and records of financial institutions to provide evidence that an investor meets or exceeds the definition of an accredited investor as defined by the Securities and Exchange Commission or other regulatory body. Once the system has received the information from the intermediary network computers and/or these third-party data sources, the system API automatically makes a determination of whether the evidence is sufficient to meet the rule for accreditation and transmits a response to the intermediary, or in the alternative, provides the information received from the third-party data sources to the intermediary in the format received or format developed by the system. This verification of accredited status and/or the data received from the third-party data sources is then stored in an encrypted data vault.

For offerings based upon Rule 506(c), the system will retransmit the accredited verification or the data to future intermediaries through which an investor seeks to transact business, provided the data is still accurate and valid and continues to evidence an investor's entitlement to accredited status.

For offerings based on the crowdfunding exemption, intermediary network computers call upon the system API to create or update investor and issuer records in the system's database which are shared among all intermediaries. These updates are done upon the occurrence of certain events including, without limitation, the creation of an offering by an issuer, the modification of an offering by an issuer, the closing of an offering by an issuer, the subscription to an offering by an investor, the modification of a subscription by an investor, the funding of an offering by an investor, and the closing of an offering by an investor. Upon attempted subscription to an offering, the intermediary network computer calls upon the external system. API with information about the subscription and requests either the investment history of the investor or whether the investor may subscribe to the offering based on the Investment Threshold rules promulgated by the SEC. The system API may determine whether, based on the investment history associated with the investor account and the Investment Threshold rules, the investor may proceed with the subscription and provides this determination in response to the API request.

Where the Investment Threshold rules require income or net worth to be entered to calculate the upper limit of the threshold—e.g., where an investor would exceed a permissible baseline threshold—the system API will alert the intermediary network computer in response to the API request which will prompt the intermediary network computer to collect this information from the investor or to initiate an income verification or asset verification process through the system. If the income verification or asset verification process is managed by the system, the investor record in the system database will be updated and will serve as the benchmark for the investor's investment threshold for as long as the information is valid pursuant to the Investment Threshold rules.

Both the accredited investor status verification databases and the crowdfunding verification databases can be coupled with electronic payments with an electronic payments and escrow function that is managed by the system or a third-party vendor. The accredited verification services or crowdfunding verification services may serve as a necessary blocker to funding an escrow account, or release of funds from the escrow account to the issuer, managed by the system or a third-party vendor.

Once the system API recognizes an investor as being compliant for the transaction, the intermediary computer network can pass electronic payment information to the system that will enable the system, or a vendor of the system, to automatically direct transfer of funds by the investor to an escrow account.

In the alternative, investors can open accounts managed by the system and the system can load funds into accounts at the direction of the investor and automatically orchestrate release of funds from the accounts into offerings through the system supported intermediaries via API provided that the investor meets the applicable compliance screening process.

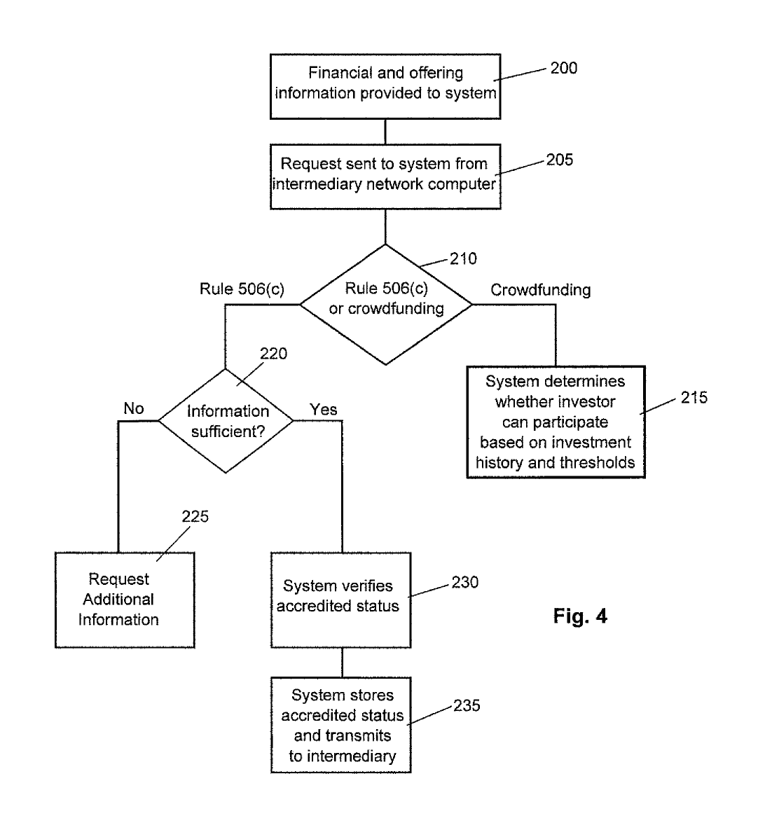

In FIG. 4, a flow chart for one embodiment of the system is shown. In step 200, information regarding investors and offerings is provided to the system. As discussed herein, the data may be received from multiple sources connected to the networked system including third party systems. In step 205, a request is sent from an intermediary network computer for authorization for an investor to participate in an offering. In step 210, the system determines if the investment is governed by Rule 506(c) or the crowdfunding exemption. For investments based on the crowdfunding exemption, in step 215 the system searches the database to find out how many offerings this investor has subscribed to and whether the investor has exceeded the investment limits for the relevant time period pursuant to the threshold rules. For investments based on Rule 506(c), in step 220 the system determines if the information received from the investor and/or third party systems and stored in the database is sufficient and or up to date for determining accredited status. If the information is insufficient, then in step 225 a request is sent to the intermediary network computer for additional information. If the information is sufficient then the system verifies the accredited status of the investor in step 230. In step 235, the system provides the information regarding the accredited status of the investor to future intermediary network computers upon request.

The embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention.

What is claimed is:

1. A method, comprising:
creating a first database comprising a financial record associated with an investor;
creating a second database comprising a record associated with an offering provided by an issuer;
the first and second databases stored in a storage medium;
a network server receiving, from a first computing device, a request for verification of a financial status of the investor as an accredited investor based on the financial record, or in the case of a non-accredited investor, the eligibility of the investor to invest in the offering based on a predetermined investment threshold;
the network server searching the database based on the request and determining if the financial record for the investor contains information sufficient to verify the accredited investor status;
the network server searching the database and determining if the investor has exceeded the investment threshold based on financial information contained in the financial record and previous subscriptions to other offerings; and,
the network server sending a message related to the status of the investor as an accredited investor and/or sending information related to whether the investor has exceeded the investment threshold, to the first computing device.

2. The method of claim 1, further comprising: sending a message to the first computing device if there is not sufficient information in the financial record to verify the accredited investor status.

3. The method of claim 1, wherein the financial record is updated with financial information from a third party system.

4. The method of claim 1, wherein the first computing device comprises an intermediary network computer that interfaces with the network server via an application programming interface (API).

5. The method of claim 4, wherein the investor submits financial information via a user interface on the intermediary network computer.

6. The method of claim 4, wherein the issuer submits information regarding an offering via a user interface on the intermediary network computer.

7. The method of claim 4, wherein the intermediary network computer sends data to the network server to update the second database upon the creation of a new offering.

8. The method of claim 4, wherein the intermediary network computer sends data to the network server upon closing of an offering by an issuer.

9. The method of claim 4, wherein the intermediary network computer sends data to the network server upon the subscription to a second offering by the investor.

10. The method of claim 1, further comprising the network server authorizing payment, recording the transaction after a payment has been successfully transferred, and sending a message regarding ownership of the financial instrument to the first computing device.

11. The method of claim 4, wherein the network server receives offering and investor information from the intermediary network computer via the API.

12. A system, comprising:
a first database comprising a financial record associated with an investor and a second database comprising a record associated with an offering provided by an issuer, the first and second databases stored in a storage medium;
a network server having an application programming interface (API), the network server configured to retrieve information from and to update the financial record and offering record;
an intermediary network computer configured to interface with the API to send a request for verification of a financial status of the investor as an accredited investor based on the financial record, or in the case of a non-accredited investor, the eligibility of the investor to invest in the offering based on a predetermined investment threshold;
wherein the network server is configured to search the database to determine if the financial record for the investor contains information sufficient to verify the status as an accredited investor;
wherein the network server is configured to search the database to determining if the investor has exceeded the investment threshold based on financial information contained in the financial record and previous subscriptions to other offerings; and,
wherein the network server sends a message related to the status of the investor as an accredited investor and/or sends information related to whether the investor has exceeded the investment threshold, to the intermediary network computer.

13. The system of claim 12, wherein the financial record in the database is updated with financial information from a third party system.

14. The system of claim 12, wherein the network server authorizes payment from an account owned by the investor.

15. The system of claim 14, wherein the issuer submits information related to the offering via a user interface on the intermediary network computer.

16. The system of claim 15, wherein the intermediary network computer automatically sends data to the network server to update the second database upon the creation of a new offering.

17. The system of claim 15, wherein the intermediary network computer automatically sends data to the network server upon the subscription to a second offering by the investor.

18. A system, comprising:
a first database comprising a financial record associated with an investor and a second database comprising a record associated with an offering provided by an issuer, the first and second databases stored in a storage medium;
a network server having an application programming interface (API), the network server configured to retrieve information from and to update the financial record and offering record;
an intermediary network computer configured to interface with the API to send a request for verification of a financial status of the investor as an accredited investor based on the financial record, or in the case of a non-accredited investor, the eligibility of the investor to invest in the offering based on a predetermined investment threshold;
means for searching the database to determine if the financial record for the investor contains information sufficient to verify the status as an accredited investor; and,
means for searching the database to determining if the investor has exceeded the investment threshold based on financial information contained in the financial record and previous subscriptions to other offerings;
means for sending a message to the intermediary network computer regarding the status of the investor as an accredited investor and/or sending a message to the intermediary network computer regarding the eligibility of the investor to invest in the offering based on the investment threshold; and,
a user interface on the intermediary network configured to receive financial information from the investor and/or information regarding the offering from the issuer.

19. The system of claim 18, wherein the financial record in the database is updated with financial information from a third party system.

20. The system of claim 18, wherein the network server is configured to interface with an electronic payment and escrow system.
